(19) United States
(12) Patent Application Publication
(10) Pub. No.: US 2017/0060333 A1
(43) Pub. Date: Mar. 2, 2017

(54) CAPACITIVE TYPE TOUCH PANEL

(71) Applicant: ABOV SEMICONDUCTOR CO., LTD., Cheongwon-gun (KR)

(72) Inventor: Seok Hyun Jee, Incheon (KR)

(73) Assignee: ABOV SEMICONDUCTOR CO., LTD.

(21) Appl. No.: 14/873,351

(22) Filed: Oct. 2, 2015

Related U.S. Application Data
(63) Continuation of application No. PCT/KR2014/002782, filed on Apr. 1, 2014.

(30) Foreign Application Priority Data
Apr. 3, 2013 (KR) 10-2013-0036324

(51) Int. Cl. G06F 3/041; G06F 3/044

(52) U.S. Cl. CPC G06F 3/0418; G06F 3/044; G06F 2203/04104

(57) ABSTRACT

A capacitive touch panel is disclosed herein. The capacitive touch panel includes a plurality of bottom transparent electrodes formed in a first direction and a plurality of top transparent electrodes formed in a second direction perpendicular to the first direction. Each of the top transparent electrodes includes a linear electrode, a plurality of first pattern electrodes, and a plurality of second pattern electrodes. The linear electrode is linearly formed in the second direction. The plurality of first pattern electrodes is formed on the first side of the linear electrode in a predetermined first pattern, and is formed at predetermined intervals in an alternately protruding and recessed form in the second direction. The plurality of second pattern electrodes is formed on the second side of the linear electrode in a predetermined second pattern, and is formed at predetermined intervals in an alternately protruding and recessed form in the second direction.

### CROSS-REFERENCE TO RELATED APPLICATION

This application is a continuation of PCT/KR2014/002782 filed on Apr. 1, 2014, which claims priority to Korean Application No. 10-2013-0036324 filed on Apr. 3, 2013, which application is incorporated herein by reference.

### TECHNICAL FIELD

The present invention relates to a capacitive touch panel and, more particularly, to a capacitive touch panel that can reduce the total resistance value of top transparent electrodes, that can reduce the number of electrode terminals used for the top transparent electrodes, and that can provide the accurate coordinate values of a touched location through the guarantee of coordinate linearity.

### BACKGROUND ART

Personal computers (PCs), portable transmission devices, and other personal dedicated information processing devices perform text and graphics processing and the like via various input devices, such as a keyboard, a mouse, and a digitizer.

Input devices including only a keyboard and a mouse cannot deal with the extended uses of products, such as PCs, as input devices used for interfaces. Accordingly, there has been a need for an input device that is simpler than a conventional keyboard and mouse, that can reduce erroneous manipulations, that enables anyone to easily perform input operations, and that enables characters to be entered by a hand while it is being carried. In particular, a touch panel is known as an input device that is simple, that reduces erroneous manipulations, that enables anyone to perform input operations while carrying the input device, and that enables characters to be entered without another input device. The detection method, structure and performance thereof are well known.

Such touch panels include: resistive touch panels (screen) in which two sheets having respective resistance components that are disposed such that they are separated by a spacer and are brought into contact with each other by pressing have been combined with each other; capacitance touch panels in which current continuously flows along the surface of a panel and electrons flowing along liquid crystals are attracted to a contact point when a finger or conductor comes into contact with a screen, thereby achieving recognition; Surface Acoustic Wave (SAW) touch panels; optical (infrared) sensor touch panels; and electromagnetic touch panels.

Resistive touch panels are configured in a form in which a plurality of films (screens) is stacked on top of each other on liquid crystals. Resistive touch panels include a film disposed on the outermost side (a portion with which a hand or pen comes into contact) and made of material that is soft and robust to scratches, a film configured to mitigate impacts, and two transparent conductive films (thin transparent conductive substrates) configured to detect input, which are sequentially superimposed on top of each other.

Accordingly, resistive touch panels enable a screen to be touched with not only a finger but also a stylus pen (a touch pen) and almost all objects that can be held in a hand of a user, and are advantageous for successive handwriting inputs or small icon touches. Since the manufacturing costs of resistive touch panels are inexpensive because the principle thereof is simple, resistive touch panels are the most widely applied touch panels. Principal devices employing resistive touch panels include portable game consoles, such as the Nintendo DS, and mobile phones, such as Samsung Anycall Haptic phones and LG Cyon Cooky phones. These devices support handwriting input method-based games, or provide neat user interfaces.

Capacitive touch panels are based on a method using static electricity that is present in the human body. That is, current is made to continuously flow along liquid crystal glass by coating the liquid crystal glass with a conductive compound, and electrons flowing on the liquid crystal glass are attracted to a contact point when a finger comes into contact with a screen. Then, sensors present at corners of the touch screen detect the electrons and thus identify an input.

Accordingly, capacitive touch panels enable touch input to be performed even by slightly grazing a screen (which presents emotional sensations), and support multi-touch functionality (which enables the concurrent recognition of a plurality of contact points). Furthermore, since the liquid crystal glass coated with a dielectric (a conductive compound) is used, there is no concern about a reduction in image quality. Principal devices employing capacitive touch panels include most smart phones that have been recently released.

The capacitance input method of capacitive touch panels is appropriate for the application of effective user interfaces to small screens, such as those of the above products. Recently, tablet PCs (such as the Samsung Galaxy Tab, the Apple iPad, etc.) equipped with screens larger than those of mobile phones have attracted attention. Most of these tablet PCs employ capacitance touch screens rather than resistive touch screens.

FIG. 1 is a plan view showing a conventional capacitive touch panel.

As shown in FIG. 1, the conventional capacitive touch panel includes a plurality of bottom transparent electrodes 110, a plurality of top transparent electrodes 120, and electrode terminals 130 and 140 connected to the respective electrodes. It will be apparent that the conventional capacitive touch panel may include components, such as a cover made of tempered glass or reinforced plastic and an optical transparent adhesive, in addition to the components shown in FIG. 1. Since these components are apparent to those skilled in the art, detailed descriptions thereof are omitted.

The plurality of bottom transparent electrodes 110 may be each formed linearly in a first direction, for example, a lateral direction, and may be formed on a lower transparent substrate (not shown).

In this case, the plurality of bottom transparent electrodes 110 may be disposed at predetermined intervals in a second direction, for example, a vertical direction.

The plurality of top transparent electrodes 120 is formed in a direction perpendicular to the plurality of bottom transparent electrodes 110. That is, the plurality of top transparent electrodes 120 is formed in the second direction perpendicular to the first direction.

In this case, the plurality of top transparent electrodes 120 may be formed on an upper transparent substrate (not shown).

In the conventional capacitive touch panel configured as described above, a mutual capacitance value is generated between the bottom transparent electrode 110 and the top transparent electrode 120 at each point where the electrodes intersect each other. When the human body comes into contact with or approaches the point, part of the mutual capacitance value generated at the intersection point is transferred to the human body due to the virtual ground phenomenon of the human body. In this case, the mutual capacitance value is reduced at the intersection point, and the recognition of contact with the human body and coordinate calculation are performed based on the change in mutual capacitance.

In the conventional capacitive touch panel, the top transparent electrodes 120 are arranged at intervals of about 5 mm based on a diameter ranging from 5 to 6 mm, which corresponds to a human body contact area. The top transparent electrodes 120 may be arranged at intervals of a maximum of 6.5 mm based on the material and thickness of the cover.

However, when the number of electrodes or electrode terminals available in the structure of the conventional capacitive touch panel is insufficient, the electrodes are arranged at wider intervals, for example, intervals of 10 mm. In this case, a problem arises in that it becomes difficult to identify contact with the human body, with the result that it becomes difficult to calculate accurate coordinates. That is, the electrode structure of the conventional capacitive touch panel has a problem in that it cannot guarantee coordinate linearity.

Therefore, there is a need for a touch panel that can guarantee coordinate linearity even when the number of available electrodes is insufficient and thus can provide the accurate coordinate values of a touched location.

### SUMMARY OF THE DISCLOSURE

Accordingly, the present invention has been made to solve the above problems occurring in the conventional technology, and an object of the present invention is to provide a capacitive touch panel that reduces the total resistance value of top transparent electrodes, thereby enhancing response speed and touch sensitivity.

More specifically, the present invention is intended to provide a capacitive touch panel in which each top transparent electrode is configured to include a linear electrode linearly formed and pattern electrodes formed on the left and right sides of the linear electrode at predetermined intervals in an alternately protruding and recessed form, thereby reducing the total resistance value of top transparent electrodes.

Another object of the present invention is to provide a capacitive touch panel that can guarantee coordinate linearity even when the number of electrode terminals is small and thus can provide the accurate coordinate values of a touched location.

Still another object of the present invention is to provide a capacitive touch panel that can reduce the number of electrode terminals, thereby reducing manufacturing costs and also improving the manufacturing yield of products.

In accordance with an aspect of the present invention, there is provided a capacitive touch panel including a plurality of bottom transparent electrodes formed in a first direction and a plurality of top transparent electrodes formed in a second direction perpendicular to the first direction, wherein each of the top transparent electrodes includes: a linear electrode configured to have a predetermined width, and linearly formed in the second direction; a plurality of first pattern electrodes formed on the first side of the linear electrode with respect to the first direction in a predetermined first pattern, and formed at predetermined intervals in an alternately protruding and recessed form in the second direction; and a plurality of second pattern electrodes formed on the second side of the linear electrode with respect to the first direction in a predetermined second pattern, and formed at predetermined intervals in an alternately protruding and recessed form in the second direction.

The first pattern electrodes may be disposed alternately with the second pattern electrodes of an top transparent electrode neighboring the first side.

The first pattern electrodes and the second pattern electrodes may be formed to be symmetrical with respect to the linear electrode.

Each of the plurality of first pattern electrodes and the plurality of second pattern electrodes may include: a first pattern linear electrode configured such that one side thereof is connected to the linear electrode; and a second pattern linear electrode configured such that one side thereof is connected to the other side of the first pattern linear electrode and the other side thereof is connected to the linear electrode.

Each of the plurality of first pattern electrodes and the plurality of second pattern electrodes may include: a first pattern linear electrode configured such that one side thereof is connected to the linear electrode; and a second pattern linear electrode configured such that one side thereof is connected to the other side of the first pattern linear electrode and the other side thereof is formed to be floated.

The first pattern electrodes and the second pattern electrodes may be formed to be symmetrical with respect to the center point of the linear electrode.

The first pattern electrodes and the second pattern electrodes may be “V” shaped patterns in the first direction.

The length of the first pattern electrodes and the second pattern electrodes formed in the first direction may be determined by considering at least one of the sensitivity of the touch panel, the total resistance value of the electrodes, and the number of terminals for the top transparent electrodes.

The first pattern electrodes and the second pattern electrodes may be formed at aligned or interleaved locations in the second direction.

The bottom transparent electrodes may be linearly formed in the first direction.

### BRIEF DESCRIPTION OF THE DRAWINGS

The above and other objects, features and advantages of the present invention will be more clearly understood from the following detailed description taken in conjunction with the accompanying drawings, in which:

FIG. 1 is a plan view showing a conventional capacitive touch panel;

FIG. 2 is a plan view showing a capacitive touch panel according to an embodiment of the present invention;

FIG. 3 is a diagram showing the detailed configuration of the top transparent electrodes shown in FIG. 2;

FIGS. 4A, 4B, 5A and 5B show plan and sectional views illustrating mutual capacitance values in a conventional touch panel and a touch panel according to the present invention;

FIG. 6A, 6B and 6C show plan views illustrating coordinate linearity in a conventional touch panel and a touch panel according to the present invention;

FIG. 7A and 7B show a plan view and an equivalent resistance model illustrating electrode resistance values in a conventional touch panel and a touch panel according to the present invention; and

FIGS. 8 to 12 show the configurations of top transparent electrodes in capacitive touch panels according to embodiments of the present invention.

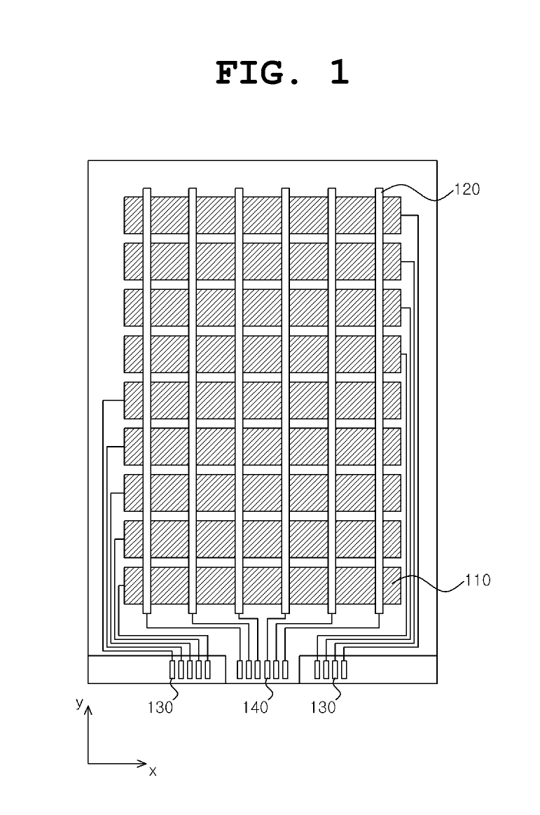

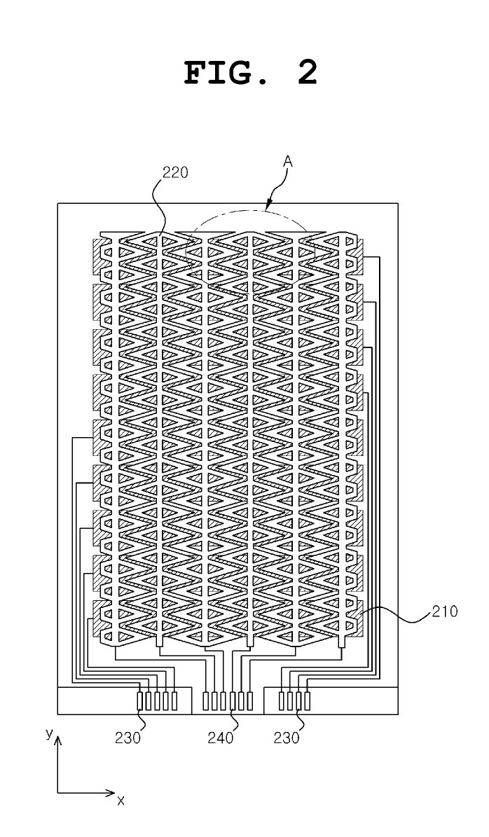

### DETAILED DESCRIPTION OF THE DISCLOSURE

Embodiments of the present invention will be described in detail with reference to the accompanying drawings. In the following description of the present invention, detailed descriptions of related well-known components or functions that may unnecessarily make the gist of the present invention obscure will be omitted.

The prevent invention is not limited to the embodiments. Throughout the accompanying drawings, the same reference symbols are assigned to the same components.

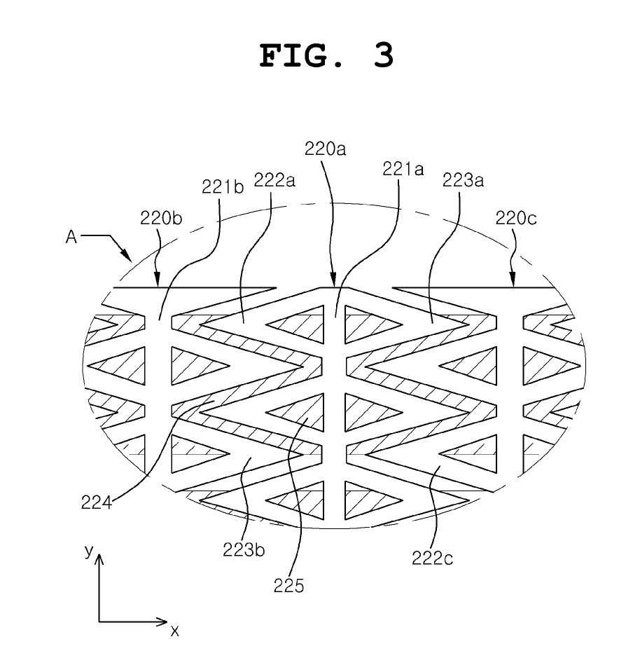

A capacitive touch panel according to an embodiment of the present invention is described in detail below with reference to FIGS. 2 to 12.

The gist of the present invention resides in providing coordinate linearity even when the number of electrodes is small and thus providing the accurate coordinate values of a touched location, and also resides in reducing the total resistance value of electrodes, increasing a change in mutual capacitance attributable to a touch and thus improving response speed and touch sensitivity.

FIG. 2 is a plan view showing a capacitive touch panel according to an embodiment of the present invention, and FIG. 3 is a diagram showing the detailed configuration of the top transparent electrodes shown in FIG. 2.

Referring to FIGS. 2 and 3, the capacitive touch panel according to the present embodiment includes a plurality of bottom transparent electrodes 210, a plurality of top transparent electrodes 220, and electrode terminals 230 and 240 connected to the respective electrodes 210 and 220.

The plurality of bottom transparent electrodes 210 is linearly formed in a first direction, for example, a lateral direction (an x axis direction). Alternatively, the plurality of bottom transparent electrodes 210 may be disposed at predetermined intervals in a second direction, for example, a vertical direction (a y axis direction).

The plurality of bottom transparent electrodes 210 functions to prevent electromagnetic waves (noise) from being transferred to the top transparent electrodes 220 by blocking electromagnetic waves radiated by a display screen that is present below the bottom transparent electrodes 210.

In this case, the plurality of bottom transparent electrodes 210 may be formed on a lower transparent substrate (not shown).

The plurality of bottom transparent electrodes 210 is electrically connected to the predetermined terminals 230 for bottom transparent electrodes, and may be connected to a control module (not shown) for detecting touched coordinate locations via the terminals 230 for bottom transparent electrodes.

The plurality of top transparent electrodes 220 is formed in a direction perpendicular to the bottom transparent electrodes 210. That is, the plurality of top transparent electrodes 220 is formed in the second direction, for example, the vertical direction, perpendicular to the first direction in which the bottom transparent electrodes 220 are formed. Alternatively, the plurality of top transparent electrodes 220 may be disposed at predetermined intervals in the first direction, for example, the lateral direction.

The top transparent electrodes 220 are configured to be spaced apart from the bottom transparent electrodes 210 by a predetermined interval, and are electrically connected to the predetermined terminals 240 for top transparent electrodes.

In the same manner, the plurality of top transparent electrodes 220 may be connected to the control module for detecting touched coordinate locations via the predetermined terminals 240 for top transparent electrodes.

In this case, the plurality of top transparent electrodes 220 may be formed on an upper transparent substrate.

As shown in FIG. 3 showing region “A” of FIG. 2, each of the plurality of top transparent electrodes 220 includes: a linear electrode 221 linearly formed in the first direction (the lateral direction); a plurality of first pattern electrodes 222 formed on the first side (for example, the left side) of the linear electrode 221 with respect to the first direction in a predetermined first pattern, and formed at predetermined intervals in an alternately protruding and recessed form in the second direction (the vertical direction); and a plurality of second pattern electrodes 223 formed on the second side (for example, the right side) of the linear electrode 221 with respect to the first direction (the lateral direction) in a predetermined second pattern, and formed at predetermined intervals in an alternately protruding and recessed form in the second direction.

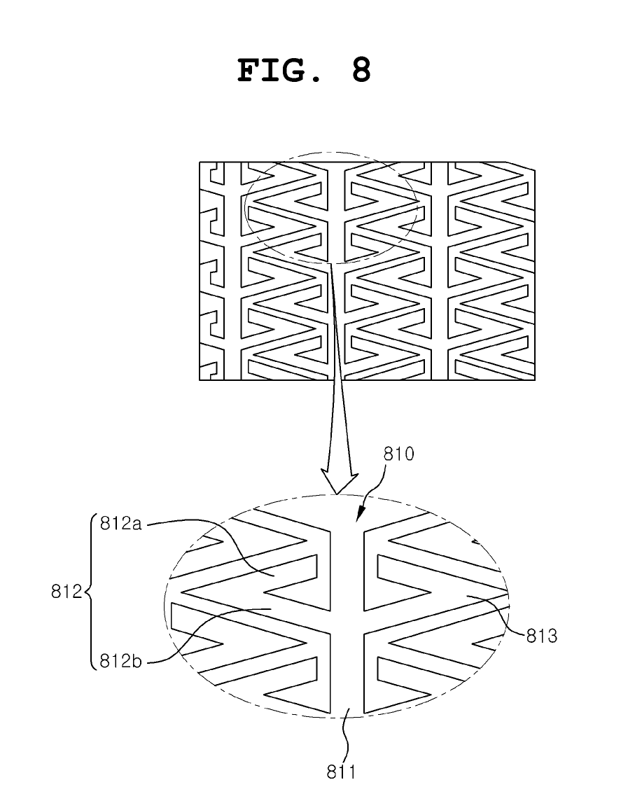

The first pattern electrodes 222a and 222c and the second pattern electrodes 223a and 223b shown in FIG. 3 correspond to a case where the first pattern electrodes 222a or 222c and the second pattern electrodes 223a or 223b are formed to be symmetrical with respect to linear electrodes 221a or 221b. The arrangement of the first and second electrodes 222 and 223 is not limited to this embodiment. Other embodiments of the arrangement of the first and second electrodes are described with reference to FIGS. 8 to 12.

The first electrode patterns 222a or 222c are disposed alternately with the second pattern electrodes 223b or 223a of an top transparent electrode 220b or 220a neighboring the first side, i.e., the left side, and the second pattern electrodes 223a or 223b are disposed alternately with the first pattern electrodes 222a or 222c of an top transparent electrode 220a or 220c neighboring the second side, i.e., the right side.

That is, the first pattern electrodes 222a of the first top transparent electrode 220a are disposed alternately with the second pattern electrodes 223b of the second top transparent electrode 220b, and the second pattern electrodes 223a of the first top transparent electrode 220a are disposed alternately with the first pattern electrodes 222c of the third top transparent electrode 220c.

The first pattern electrodes 222a and 222c and the second pattern electrodes 223a and 223b shown in FIG. 3 are each configured in a form in which two pattern linear electrodes are connected to each other. For example, each of the first pattern electrodes 222a includes a first pattern linear electrode configured such that one side thereof is connected to the linear electrode 221a and a second pattern linear electrode configured such that one side thereof is connected to the linear electrode 221a and the other side thereof is connected to the other side of the first pattern linear electrode. It will be apparent that the second pattern electrodes 223a are formed to be symmetrical to the first pattern electrodes 222a with respect to the linear electrode 221a. The first portions 225 of the bottom transparent electrodes are exposed through gaps between the first pattern linear electrodes of the first top transparent electrode 220a and the second pattern linear electrodes of the first top transparent electrode 220a. Furthermore, the second portions 224 of the bottom transparent electrodes are exposed through gaps between the first pattern linear electrodes of the first top transparent electrode 220a and the second pattern linear electrodes of the neighboring second top transparent electrode 220b. In this case, the second portions 224 of the bottom transparent electrodes are also exposed through gaps between the second pattern linear electrodes of the first top transparent electrode 220a and the first pattern linear electrode of the neighboring second top transparent electrode 220b.

Moreover, the leftmost and rightmost top transparent electrodes of the top transparent electrodes according to the present embodiment may have left or right side pattern electrodes that are formed in different shapes that fit regions where the electrodes are formed, as shown in FIG. 2.

As described above, in the capacitive touch panel according to the present embodiment, each of the top transparent electrodes may include the “V”-shaped pattern electrodes that are connected to the linear electrode and are formed in the first direction. It will be apparent that the pattern electrodes of the present invention are not limited to the “V”-shaped pattern electrodes but may include all type of pattern electrodes as long as the pattern electrodes of each top transparent electrode are disposed alternately with those of a neighboring top transparent electrode.

Furthermore, the first pattern electrodes and the second pattern electrodes may be formed to a predetermined length in the first direction. In this case, the length of the pattern electrodes may be determined by considering at least one of the sensitivity of the touch panel, the total resistance value of the electrodes, and the number of terminals for the top transparent electrodes. Furthermore, the pattern of the pattern electrodes may be also determined by considering the sensitivity, the total resistance value of the electrodes and the like.

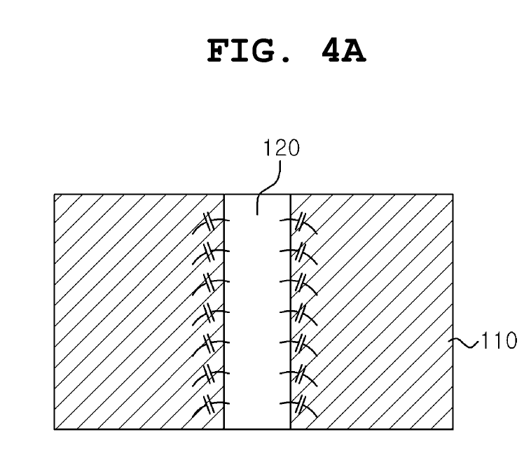

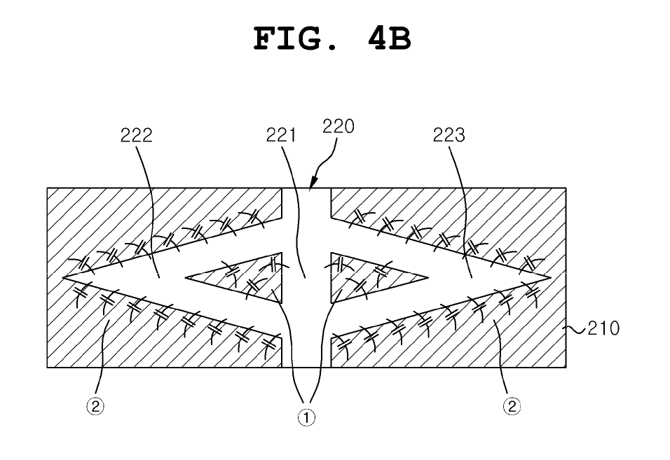

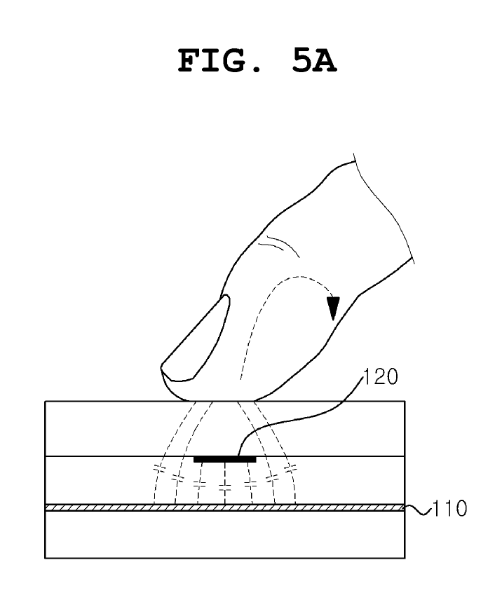

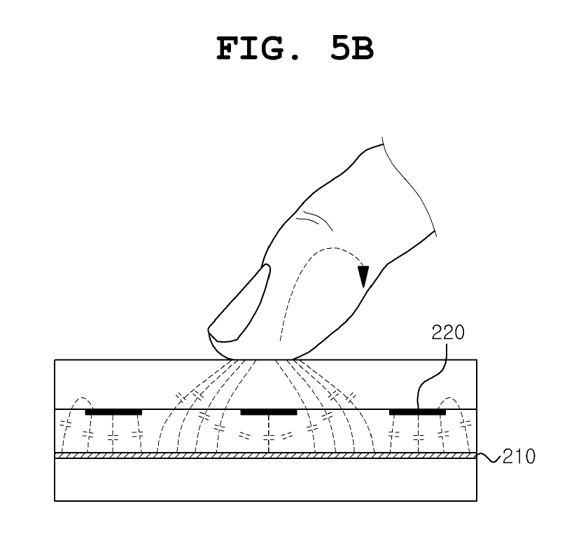

FIGS. 4A, 4B, 5A, and 5B show plan and sectional views illustrating mutual capacitance values in a conventional touch panel and a touch panel according to the present invention.

As shown in FIGS. 4A, 4B, 5A, and 5B, in the conventional capacitive touch panel, a mutual capacitance value is generated only between a bottom transparent electrode 110 and an top transparent electrode 120 that are linearly formed, and part of the mutual capacitance value is transferred to the human body via a hand of a user during contract with the human body. The conventional capacitive touch panel has the problem of poor sensitivity because a change in mutual capacitance is small during a touch.

In contrast, in the capacitive touch panel of the present invention, a mutual capacitance value generated between a bottom transparent electrode 210 and an top transparent electrode 220 is generated via various paths compared to that of the conventional touch panel. That is, a mutual capacitance value is generated between the bottom transparent electrode 210 and the linear electrode 221, between the bottom transparent electrode 210 and a first pattern electrode 222, and between the bottom transparent electrode 210 and a second pattern electrode 223. Accordingly, the generated mutual capacitance value is large. Furthermore, each of the first pattern electrode 222 and the second pattern electrode 223 is divided into a first pattern linear electrode and a second pattern linear electrode, as described with reference to FIG. 3. Mutual capacitance is generated between the bottom transparent electrode 210, exposed via gaps between the first pattern linear electrode and the second pattern linear electrode, and the individual portions (the first pattern linear electrode and the second pattern linear electrode) of the top transparent electrode 220, thereby enhancing the sensitivity of a touch operation. As shown in FIGS. 3, 4A and 4B, the first component \textcircled{1} of mutual capacitance is generated between the exposed first portion 225 of the bottom transparent electrode 210 and the first pattern electrode 222 of the top transparent electrode 220, and the second component of the mutual capacitance is generated between the exposed second portion 224 of the bottom transparent electrode 210 and the first pattern electrode 222 of the top transparent electrode 220.

Accordingly, a change in mutual capacitance transferred to the human body via a hand of a user during contact with the human body of the user is large and thus sensitivity is enhanced, thereby providing the advantage of easily calculating the coordinate values of a touched portion.

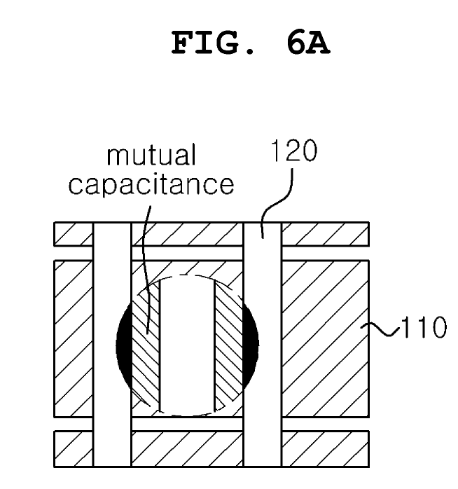

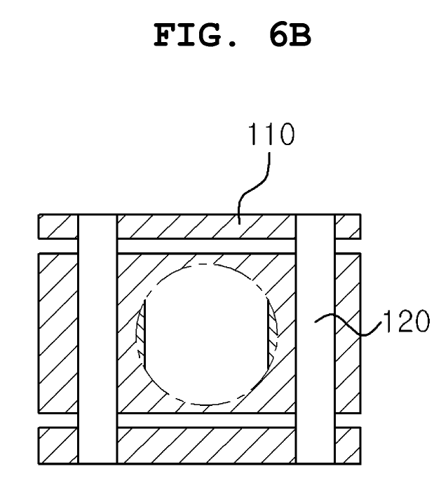

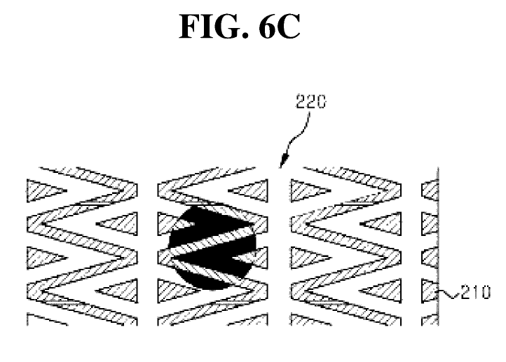

FIGS. 6A, 6B and 6C show plan views illustrating coordinate linearity in a conventional touch panel and a touch panel according to the present invention. FIGS. 6A, 6B and 6C show an effective touch area and a mutual capacitance phenomenon during contact with the human body.

As shown in FIG. 6A, when the intervals between linearly formed top transparent electrodes 120 are narrow, a bottom transparent electrode 110 and two top transparent electrodes 120 are brought into contact by the human body of a user, and thus a change in mutual capacitance equal to or larger than a predetermined value is generated between the electrodes. However, in the case of FIG. 6A, the intervals between the top transparent electrodes 120 must be formed to be narrow, and thus the number of terminals for connection to a control module must be large, resulting in an increase in manufacturing costs.

FIG. 6B shows a case where the intervals between top transparent electrodes 120 are formed to be wider than those of FIG. 6A. As shown in FIG. 6B, the intervals between the top transparent electrodes 120 are formed to be wide, and thus there occurs a case where a bottom transparent electrode 110 and two top transparent electrode 120 are not brought into contact by the human body of a user. In this case, a change in mutual capacitance rarely occurs, and thus a problem arises in that it is difficult to calculate the coordinates of a touched portion. That is, a problem arises in that sensitivity is low.

In contrast, in the case of the present invention shown in FIG. 6C, although the intervals between top transparent electrodes 220 are the same as those of FIG. 6B, a change in mutual capacitance equal to or larger than a predetermined value is generated between two pattern electrodes and a bottom transparent electrode by the alternately disposed first and second pattern electrode of the top transparent electrodes 220 even when a touch of a user occurs, as shown in FIG. 6B. Accordingly, even when the number of terminals for the top transparent electrodes 220 is small, the accurate coordinates of a touched portion can be calculated. That is, the present invention makes use of alternately disposed pattern electrodes having a predetermined pattern, and thus can provide coordinate linearity even when the number of terminals is small. Accordingly, the present invention can provide the accurate coordinate values of a touched portion using the coordinate linearity.

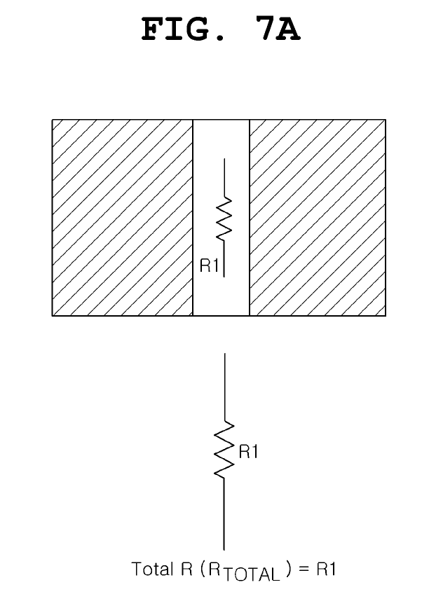

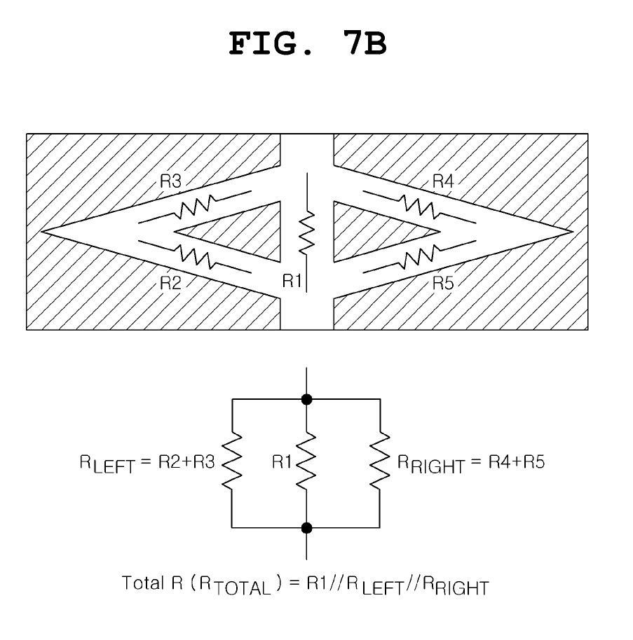

FIGS. 7A and 7B show a plan view and an equivalent resistance model illustrating electrode resistance values in a conventional touch panel and a touch panel according to the present invention.

As shown in FIG. 7A, in the case of the conventional touch panel, an top transparent electrode is composed of a single linear electrode, and thus the total resistance value of the top transparent electrode is R1.

In contrast, as shown in FIG. 7B, in the case of the touch panel according to the present invention, an top transparent electrode includes a linear electrode and left and right pattern electrodes formed in a predetermined pattern. Accordingly, resistance R1 formed by the linear electrode, resistance R_{LEFT} (=R2+R3) formed by the first pattern electrode, and resistance R_{RIGHT} (=R4+R5) formed by the second pattern electrode have a parallel relationship. Therefore, according to the present invention, the total resistance value of top transparent electrodes is reduced, which can increase the speed of response to a touch.

FIG. 8 shows the configuration of top transparent electrodes in a capacitive touch panel according to an embodiment the present invention.

Referring to FIG. 8, in an top transparent electrode 810 according to the present embodiment, a first pattern electrode 812 and a second pattern electrode 813 are formed to be symmetrical to each other with respect to a linear electrode 811, like those of FIG. 3, and have a pattern different from that of FIG. 3.

The first pattern electrode 812 shown in FIG. 8 includes a first pattern linear electrode 812b configured such that one side thereof is connected to the linear electrode 811 and a second pattern linear electrode 812a configured such that one side thereof is connected to the other side of the first pattern linear electrode 812b and the other side thereof is formed to be floated.

Since the second pattern electrode 813 is formed to be symmetrical to the first pattern electrode 812 with respect to the linear electrode 811, it will be apparent that the second pattern electrode 813 includes the two pattern linear electrodes that constitute the first pattern electrode 812.

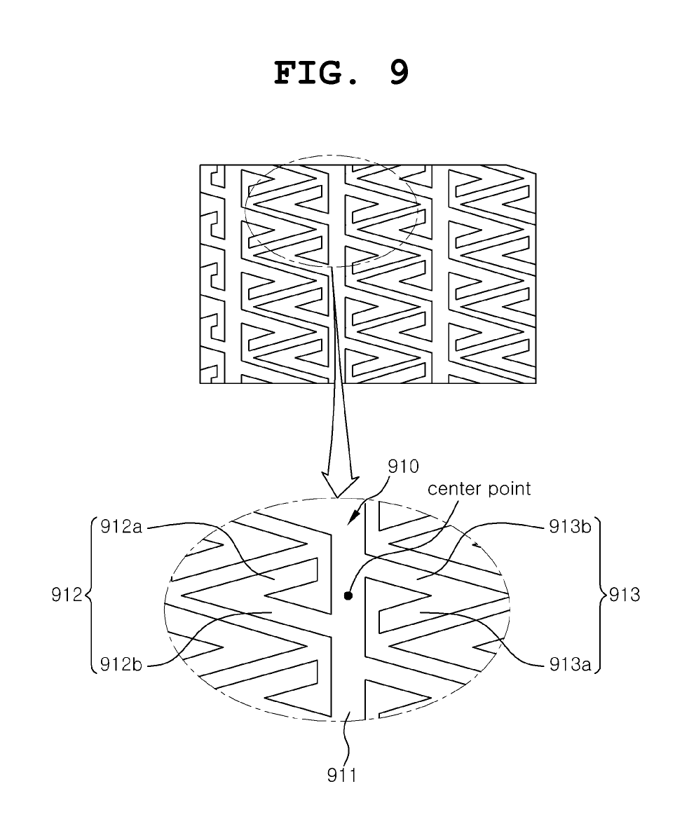

The top transparent electrodes shown in FIGS. 3 and 8 correspond to cases where the first pattern electrode and the second pattern electrode are formed to be symmetrical with respect to the linear electrode. The top transparent electrode according to the present invention is not limited to those cases. A first pattern electrode and a second pattern electrode may be formed to be symmetrical with respect to the center point of a linear electrode, or may be formed at interleaved locations of the linear electrode, rather than aligned locations of the linear electrode. This is described with reference to FIGS. 9 to 12 below.

FIGS. 9 to 12 show the configurations of top transparent electrodes in capacitive touch panels according to embodiments of the present invention.

FIG. 9 shows a case where the first pattern electrode 912 and second pattern electrode 913 of an top transparent electrode 910 are formed to be symmetrical with respect to the center point of a linear electrode 911. As shown in FIG. 9, in the top transparent electrode 910 according to the present embodiment, the first pattern electrode 912 and the second pattern electrode 913 are formed to be symmetrical with respect to the center point of the linear electrode 911. That is, the first pattern linear electrode 913a of the second pattern electrode 913 is formed to be symmetrical to the first pattern linear electrode 912a of the first pattern electrode 912 with respect to the center point of the linear electrode 911, and the second pattern linear electrode 913b of the second pattern electrode 913 is formed to be symmetrical to the second pattern linear electrode 912b of the first pattern electrode 912 with respect to the center point of the linear electrode 911.

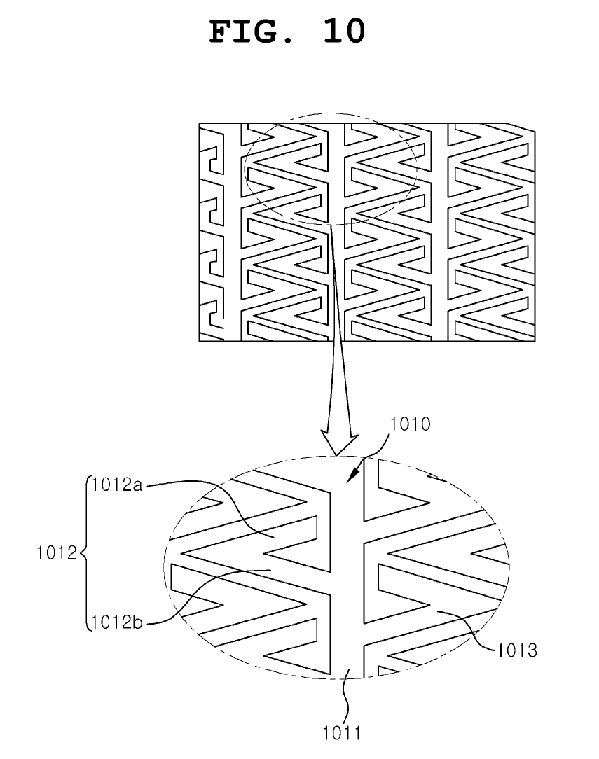

The first pattern electrode 912 and second pattern electrode 913 of the top transparent electrode 910 shown in FIG. 9 are formed on the left and right sides of the linear electrode 911 at aligned locations in the second direction (the vertical direction) in which the linear electrode 911 is formed. FIGS. 10 to 12 show cases where a first pattern electrode and a second pattern electrode are formed at interleaved locations of a linear electrode that is formed in the second direction. These cases are described in detail below.

In each of the top transparent electrodes 1010, 1110 and 1210 shown in FIGS. 10 to 12, a plurality of first pattern electrodes 1012, 1112 or 1212 and a plurality of second pattern electrodes 1013, 1113 or 1213 formed in an alternately protruding and recessed form are formed at interleaved locations of a linear electrode 1011, 1111 or 1211 in a predetermined pattern.

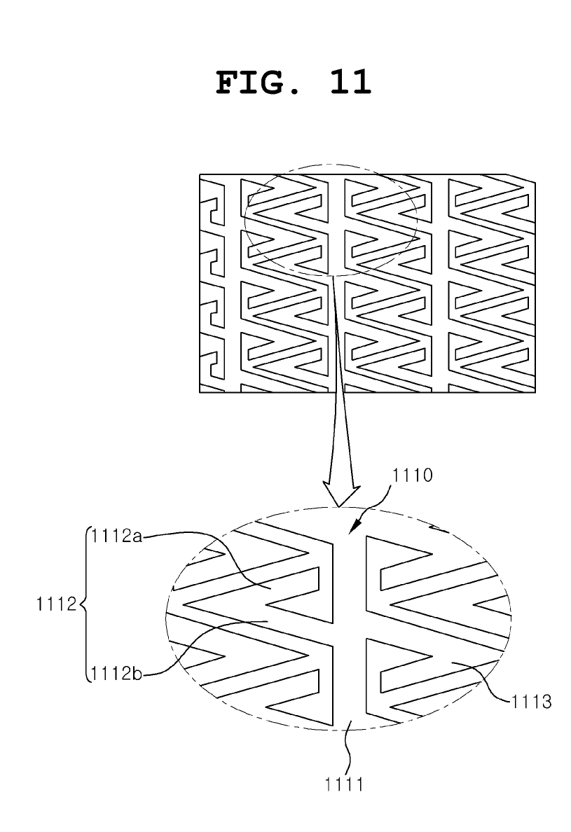

As an example, as shown in FIGS. 10 and 11, each of the first pattern electrodes 1012 or 1112 includes a first pattern linear electrode 1012b or 1112b configured such that one side thereof is connected to a corresponding linear electrode 1011 or 1111 and a second pattern linear electrode 1012a or 1112a configured such that one side thereof is connected to the other side of the first pattern linear electrode 1012b or 1112b and the other side thereof is formed to be floated. The second pattern electrodes 1013 or 1113 are formed on the right side of the linear electrode 1011 or 1111 in the state of being interleaved with the first pattern electrodes 1012 or 1112. In the case of FIG. 10, each pattern linear electrode having a floated side is formed in the upper region of a region where a corresponding second pattern electrode 1013 is formed; and in the case of FIG. 11, each pattern linear electrode having a floated side is formed in the lower region of a region where a corresponding second pattern electrode 1113 is formed.

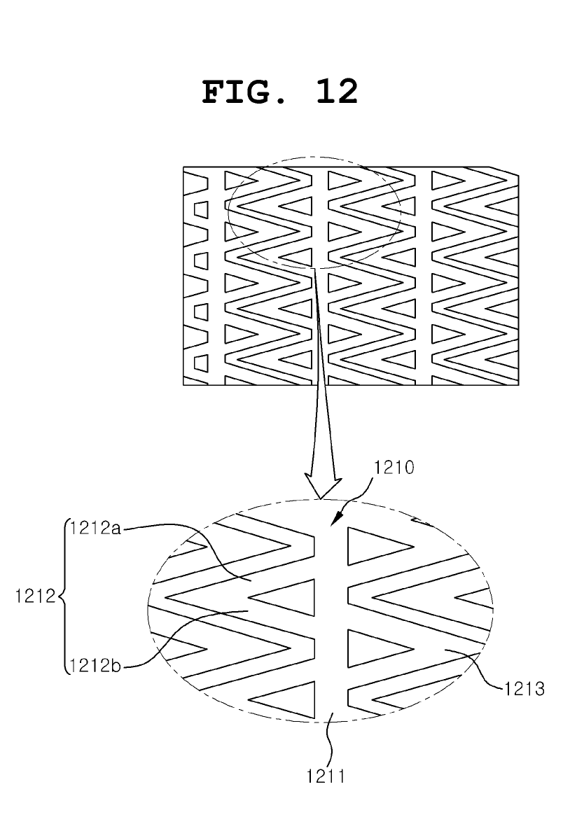

As another example, as shown in FIG. 12, each of the first pattern electrodes 1212 includes a first pattern linear electrode 1212a configured such that one side thereof is connected to a corresponding linear electrode 1211 and a second pattern linear electrode 1212b configured such that one side thereof is connected to the linear electrode 1211 and the other side thereof is connected to the other side of the first pattern linear electrode 1212a. The second pattern electrodes 1213 are formed on the right side of the linear electrode 1211 in the state of being interleaved with the first pattern electrodes 1212.

Although the pattern of the first pattern electrodes has been described as being the same as that of the second pattern electrodes except that they differ only in the location or direction, the present invention is not limited thereto, but may employ different patterns. For example, the first pattern electrodes may be formed in the pattern of the first pattern electrodes of one of FIGS. 8 to 11, whereas the second pattern electrodes may be formed in the pattern of the second pattern electrodes of FIG. 12.

As described above, in the capacitive touch panel according to the present invention, each top transparent electrode is formed to include a linear electrode and two pattern electrodes formed in a direction, for example, the first direction, in which bottom transparent electrodes are formed, thereby reducing the total resistance value of top transparent electrodes and thus increasing the speed of response to a touch. The pattern electrodes are employed on the left and right sides of each linear electrode, thereby providing coordinate linearity through the generation of a large mutual capacitance value even when the number of terminals is small and thus providing the accurate coordinate values of a touched portion using the coordinate linearity.

According to the present invention, each top transparent electrode is configured to include a linear electrode linearly formed and pattern electrodes formed on the left and right sides of the linear electrode at predetermined intervals in an alternately protruding and recessed form, thereby improving response speed through a reduction in the total resistance value of electrodes and also enhancing touch sensitivity through an increase in a mutual capacitance change attributable to a touch.

The present invention is configured such that the pattern electrodes of each top transparent electrode are arranged alternately with those of a neighboring top transparent electrode, and thus can guarantee coordinate linearity even when the number of electrode terminals is small, thereby providing the accurate coordinate values of a touched location.

The present invention can reduce the number of electrode terminals, and thus can reduce the number of ports connected to top transparent electrodes in a control module for detecting touch coordinates, such as a microcontroller (MCU), thereby reducing the manufacturing costs of products and also improving the manufacturing yield of products through a reduction in defect rate.

While the present invention has been described in conjunction with specific details, such as specific configuration elements, and limited embodiments and diagrams above, these are provided merely to help an overall understanding of the present invention, the present invention is not limited to these embodiments, and various modifications and variations can be made based on the above description by those having ordinary knowledge in the art to which the present invention pertains.

Therefore, the technical spirit of the present invention should not be determined based on only the described embodiments, and the following claims, all equivalents to the claims, and equivalent modifications should be construed as falling within the scope of the spirit of the present invention.

What is claimed is:

1. A capacitive touch panel comprising a plurality of bottom transparent electrodes formed in a first direction and a plurality of top transparent electrodes formed in a second direction perpendicular to the first direction,
wherein each of the top transparent electrodes comprises:
a linear electrode configured to have a predetermined width, and linearly formed in the second direction;
a plurality of first pattern electrodes formed on a first side of the linear electrode with respect to the first direction in a predetermined first pattern, and formed at predetermined intervals in an alternately protruding and recessed form in the second direction; and
a plurality of second pattern electrodes formed on a second side of the linear electrode with respect to the first direction in a predetermined second pattern, and formed at predetermined intervals in an alternately protruding and recessed form in the second direction; and
wherein each of the plurality of first pattern electrodes and the plurality of second pattern electrodes comprises:
a first pattern linear electrode configured such that one side thereof is connected to the linear electrode; and
a second pattern linear electrode configured such that one side thereof is connected to a remaining side of the first pattern linear electrode and a remaining side thereof is connected to the linear electrode or is formed to be floated.

2. The capacitive touch panel of claim 1, wherein mutual capacitance between each of the top transparent electrodes and each of the bottom transparent electrodes includes a sum of:
a first component including capacitance between first portions of the bottom transparent electrode, exposed via gaps between the first pattern linear electrodes and the second pattern linear electrodes, and the first pattern linear electrode, and capacitance between the first portions and the second pattern linear electrodes; and
a second component including capacitance between second portions of the bottom transparent electrode, exposed via gaps between first pattern linear electrodes and second pattern linear electrodes of neighboring top transparent electrode, and the first pattern linear electrodes.

3. The capacitive touch panel of claim 1, wherein a length of the first pattern electrodes and the second pattern electrodes formed in the first direction is determined by considering at least one of sensitivity of the touch panel, a total resistance value of the electrodes, and a number of terminals for the top transparent electrodes.

4. The capacitive touch panel of claim 1, wherein the first pattern electrodes are disposed alternately with second pattern electrodes of a top transparent electrode neighboring the first side.

5. The capacitive touch panel of claim 1, wherein the first pattern electrodes and the second pattern electrodes are formed to be symmetrical with respect to the linear electrode.

6. The capacitive touch panel of claim 1, wherein the first pattern electrodes and the second pattern electrodes are formed to be symmetrical with respect to a center point of the linear electrode.

7. The capacitive touch panel of claim 1, wherein the first pattern electrodes and the second pattern electrodes are formed at aligned or interleaved locations in the second direction.

8. The capacitive touch panel of claim 1, wherein the bottom transparent electrodes are linearly formed in the first direction.
